(19) United States
(12) Patent Application Publication
(10) Pub. No.: US 2026/0077455 A1
(43) Pub. Date: Mar. 19, 2026

(54) Quick Release Bit Holder

(71) Applicant: HO-TIEN CHEN, TAINAN CITY (TW)

(72) Inventor: HO-TIEN CHEN, TAINAN CITY (TW)

(21) Appl. No.: 18/890,455

(22) Filed: Sep. 19, 2024

(51) Int. Cl. B25B 23/00

(52) U.S. Cl. CPC B25B 23/0035

(57) ABSTRACT

This invention relates to a quick release bit holder, which includes at least a main body and a sleeve. A first rod provided at the rear end of said main body, a second rod provided at the front end of said main body, and said second rod successively provided with a first outer surrounding, a second outer surrounding and a third outer surrounding from back to front. The outer diameter of said first outer surrounding is larger than the outer diameter of said second outer surrounding, and the outer diameter of said second outer surrounding is larger than the outer diameter of said third outer surrounding. A plurality of ball holes provided around said third outer surrounding, a plurality of balls arranged individually in each ball hole, and a first limit position member provided at the front end of said third outer surrounding. Said sleeve mounted at the front end of said main body, an first inner surrounding provided at the inner rear end of said sleeve, a second inner surrounding provided at the inner front end of said sleeve, and the inner diameter of said first inner surrounding is larger than the inner diameter of said second inner surrounding. A first annular groove provided at said second inner surrounding, an circlip provided in said first annular groove, said circlip clamped the third outer surrounding of said main body and moved thereon.

### BACKGROUND OF THE INVENTION

### 1. Field of the Invention

This invention relates to a quick release bit holder, particularly to a bit holder that can be applied to the nose cone of various power screwdrivers or to various screwdriver tools and has a quick release function for the bit.

### 2. Description of the Prior Art

Common power screwdrivers, such as U.S. Pat. No. 10,406,661B2 “NOSEPIECE AND MAGAZINE FOR POWER SCREWDRIVER”, which discloses a power screwdriver with nose cone. A bit holder is provided in the nose cone, the bit holder is used to set and replace various bits, and can extend the length of the bit. The aforementioned nose cone is used to position and stabilize the aforementioned bit holder, and the depth of the nose cone can be adjusted to limit the depth of the locking screw to prevent the screw from locking through the plates.

Since the smallest hole diameter inside the nose cone is about 11.2 mm, the bit holders currently applicable to the nose cone are all plug-in bit holders (such as the bit holder disclosed in FIG. 1 of U.S. Pat. No. 10,406,661B2). However, this kind of plug-in bit holder is difficult to remove and replace directly by hand during use. Tools such as clips must be used to assist in the replacement of the bit. Moreover, the bit in the plug-in bit holder is easy to loosen after being used for a period of time, so it is very inconvenient to use.

Another prior art is U.S. Pat. No. D478,263S “BIT HOLDER”, which is a traditional and common quick-release bit holder. Its advantage is that the bit can be quickly replaced through a spring quick-release structure. However, since a spring must be installed inside this quick-release structure, its outer diameter is much larger than that of the plug-in bit holder, so it cannot be used in conjunction with the nose cone of the power screwdriver. Moreover, the user must continue to press the spring to replace the bit holder, which will also cause inconvenience to the user.

For this reason, the inventor having much experience in the manufacturing and research and development of construction, screws and various tools, understands and researches the problem of the foregoing bit holder and hence devised this invention.

### SUMMARY OF THE INVENTION

The objective of this invention is to provide a bit holder that can be used in conjunction with the nose cone of a power screwdriver and has a quick-release function. This invention uses a new quick-release structure to allow the bit holder to have the smallest outer diameter, and its outer diameter can be adjusted to the same or smaller outer diameter as various bit holders currently on the market according to usage requirements (the maximum outer diameter of the bit holder of the present invention can be less than 11.2 mm). Furthermore, the present invention can use a composite structure of multiple materials to reduce the manufacturing cost of the quick-release bit holder. In this way, the present invention can be applied to various screwdriver tools, and the bit can be replaced more conveniently through the two-stage switch to improve the efficiency of screw locking.

The objective of this invention is to offer an innovative quick release bit holder, which includes at least a main body and a sleeve. A first rod provided at the rear end of said main body, a second rod provided at the front end of said main body, a joint provided at the rear end of said first rod, and a recess provided at the middle position of the front end of said second rod; said second rod successively provided with a first outer surrounding, a second outer surrounding and a third outer surrounding from back to front, the outer diameter of said first outer surrounding is larger than the outer diameter of said second outer surrounding, and the outer diameter of said second outer surrounding is larger than the outer diameter of said third outer surrounding; a plurality of ball holes provided around said third outer surrounding, a plurality of balls arranged individually in each ball hole, said balls can partially extend into said recess, and a first limit position member provided at the front end of said third outer surrounding. Said sleeve mounted at the front end of said main body, an first inner surrounding provided at the inner rear end of said sleeve, a second inner surrounding provided at the inner front end of said sleeve, and the inner diameter of said first inner surrounding is larger than the inner diameter of said second inner surrounding; said first inner surrounding correspondingly mounted on the second outer surrounding of said second rod, said second inner surrounding correspondingly mounted on the third outer surrounding of said second rod; a first annular groove provided at said second inner surrounding, an circlip provided in said first annular groove, said circlip clamped the third outer surrounding of said main body and moved thereon; and a three-dimensional anti-slip portion provided on the outer surface of said sleeve.

The quick release bit holder of the present invention, wherein said ball holes can be provided in front of the rearmost end of the movement position of said circlip, to let the balls in said ball holes form an obstruction structure, allowing the user to more clearly feel the opening and closing status of said sleeve and can strengthen the positioning effect of said sleeve.

The quick release bit holder of the present invention, wherein said ball holes can be provided at the rear end of said third outer surrounding, a second limit position member provided in front of said ball holes, a raised portion provided between said first limit position member and said second limit position member, and said raised portion is an obstruction structure. Said raised portion can prevent said sleeve from moving to the open position due to strong vibration, and causing a bit in said recess to fall off.

The quick release bit holder of the present invention, wherein said main body can be an integrally formed structure or an assembled structure. The assembled main body can be provided with a housing on the rear end of said second rod, said first rod is clamped and fixed by said second rod and said housing, and said first outer surrounding provided on said housing. Said second outer surrounding can be provided on said second rod or said housing to reduce more manufacturing costs and enhance market competitiveness. Moreover, said assembled main body can adjust the distribution of its ferromagnetism, said second rod can be made of a ferromagnetic metal material, and said housing can be made of a non-ferromagnetic material, so the outer periphery of said second rod will not have ferromagnetism, to prevent the outer periphery of said second rod from attracting external metal shavings or impurities and affecting the use of the bit holder.

### BRIEF DESCRIPTION OF DRAWINGS

This invention will be better understood by referring to the accompanying drawings, wherein:

FIG. 1 is a stereogram of the first embodiment of the present invention;

FIG. 2 is an explosion diagram of FIG. 1;

FIG. 3 is a cross-sectional view of the sleeve of FIG. 2;

FIG. 4 is a cross-sectional view of the main body of FIG. 2;

FIG. 5 is a first operation diagram of FIG. 1;

FIG. 6 is a second operation diagram of FIG. 1;

FIG. 7 is a stereogram of the second embodiment of the present invention;

FIG. 8 is an explosion diagram of FIG. 7;

FIG. 9 is a cross-sectional view of the sleeve of FIG. 8;

FIG. 10 is a cross-sectional view of the main body of FIG. 8;

FIG. 11 is a first operation diagram of FIG. 7;

FIG. 12 is a second operation diagram of FIG. 7;

FIG. 13 is a stereogram of the third embodiment of the present invention;

FIG. 14 is an explosion diagram of FIG. 13;

FIG. 15 is a cross-sectional view of the sleeve of FIG. 14;

FIG. 16 is a cross-sectional view of the main body of FIG. 14;

FIG. 17 is a first operation diagram of FIG. 13;

FIG. 18 is a second operation diagram of FIG. 13;

FIG. 19 is a stereogram of the fourth embodiment of the present invention;

FIG. 20 is an explosion diagram of FIG. 19;

FIG. 21 is a cross-sectional view of the sleeve of FIG. 20;

FIG. 22 is a cross-sectional view of the main body of FIG. 20;

FIG. 23 is a first operation diagram of FIG. 19;

FIG. 24 is a second operation diagram of FIG. 19;

FIG. 25 is the first embodiment of the three-dimensional anti-slip portion of the sleeve of the present invention;

FIG. 26 is the second embodiment of the three-dimensional anti-slip portion of the sleeve of the present invention;

FIG. 27 is the third embodiment of the three-dimensional anti-slip portion of the sleeve of the present invention;

FIG. 28 is the fourth embodiment of the three-dimensional anti-slip portion of the sleeve of the present invention;

FIG. 29 is a first embodiment of the assembled structure of the main body of the present invention;

FIG. 30 is an assembly diagram of FIG. 29;

FIG. 31 is a second embodiment of the assembled structure of the main body of the present invention;

FIG. 32 is an assembly diagram of FIG. 31;

FIG. 33 is a first operation diagram of the present invention applied to a power screwdriver with a nose cone; and

FIG. 34 is a second operation diagram of the present invention applied to a power screwdriver with a nose cone.

Wherein:
main body 1
first rod 11
joint 111
second rod 12
recess 121
housing 122
first outer surrounding 123
second outer surrounding 124
third outer surrounding 125
ball holes 126
first limit position member 127
third annular groove 1271
second positioning ring 1292
second limit position member 128
raised portion 129
second annular groove 1291
first positioning ring 1292
magnet 13
steel ball 14
sleeve 2
first inner surrounding 21
second inner surrounding 22
first annular groove 221
circlip 23
three-dimensional anti-slip portion 24
sealing ring 25
bit 3

### DETAILED DESCRIPTION OF THE PREFERRED EMBODIMENT

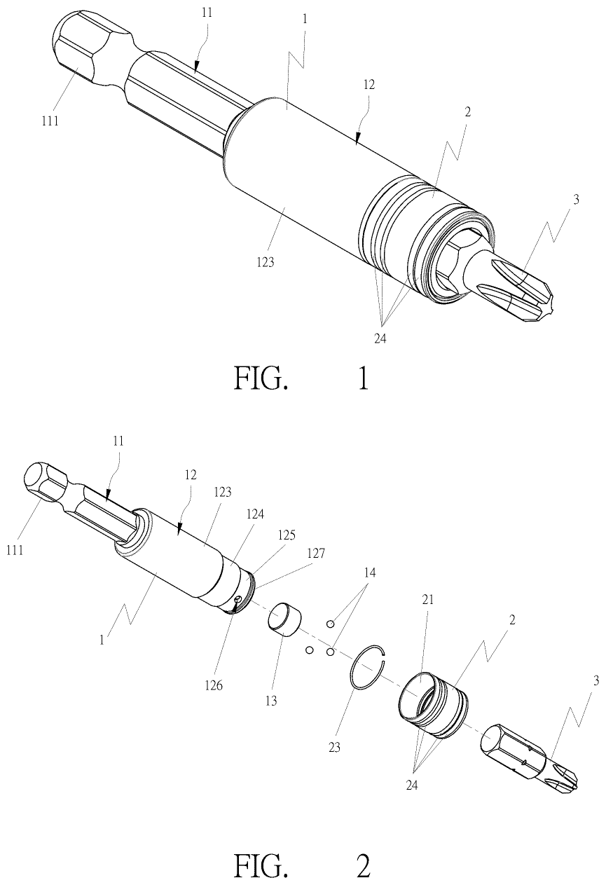

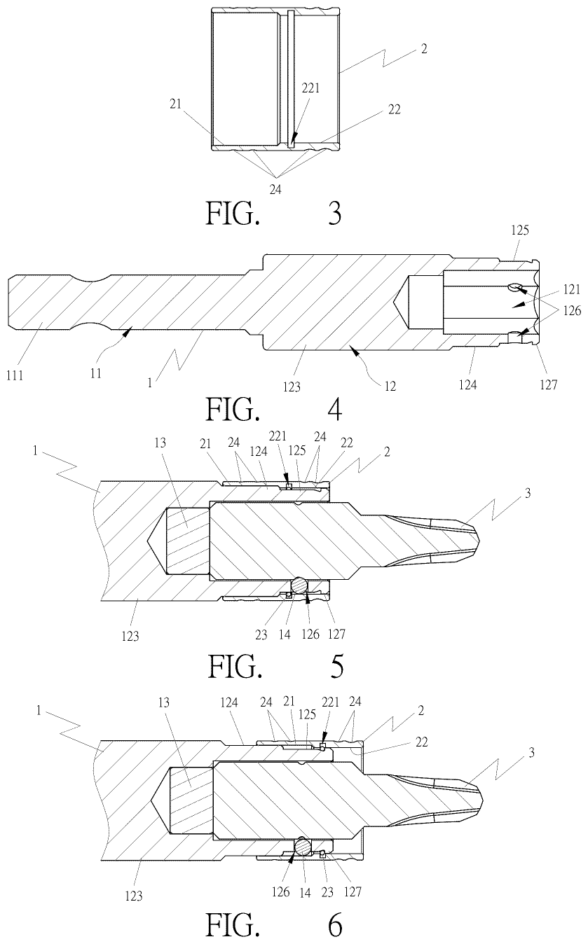

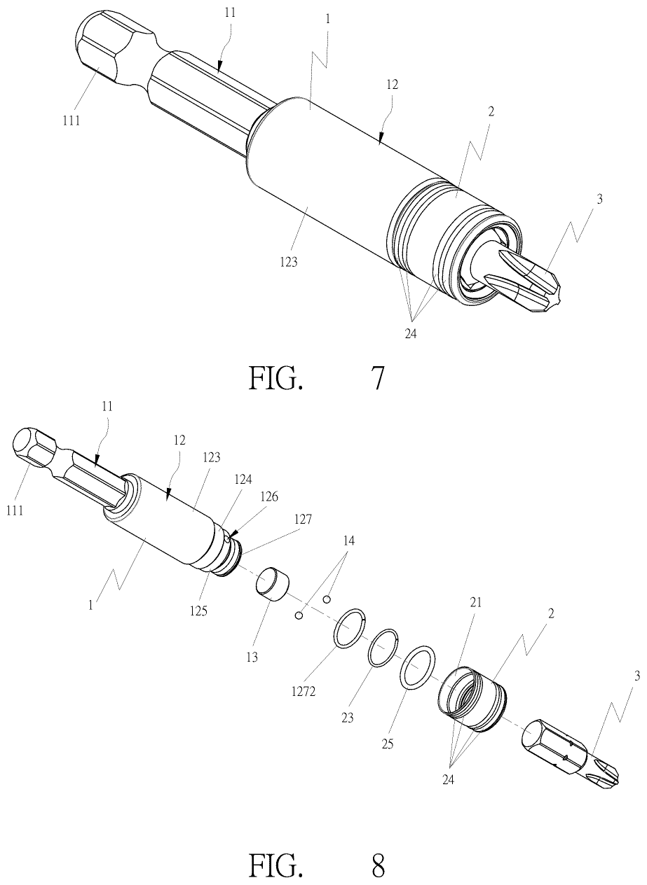

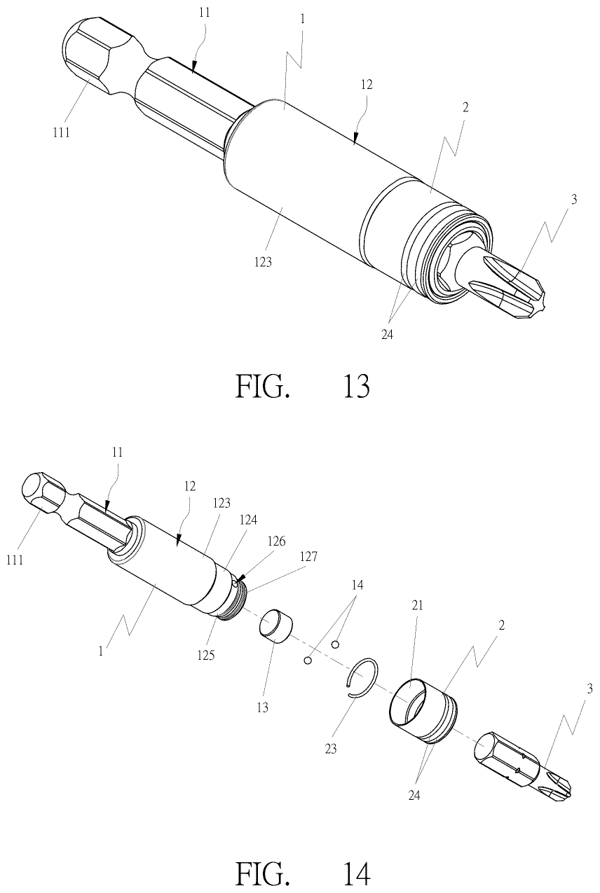

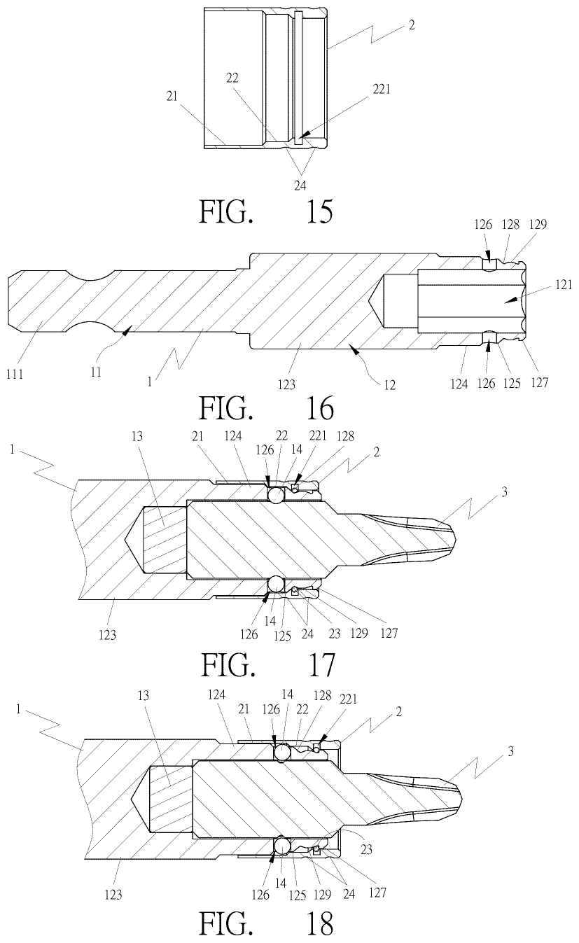

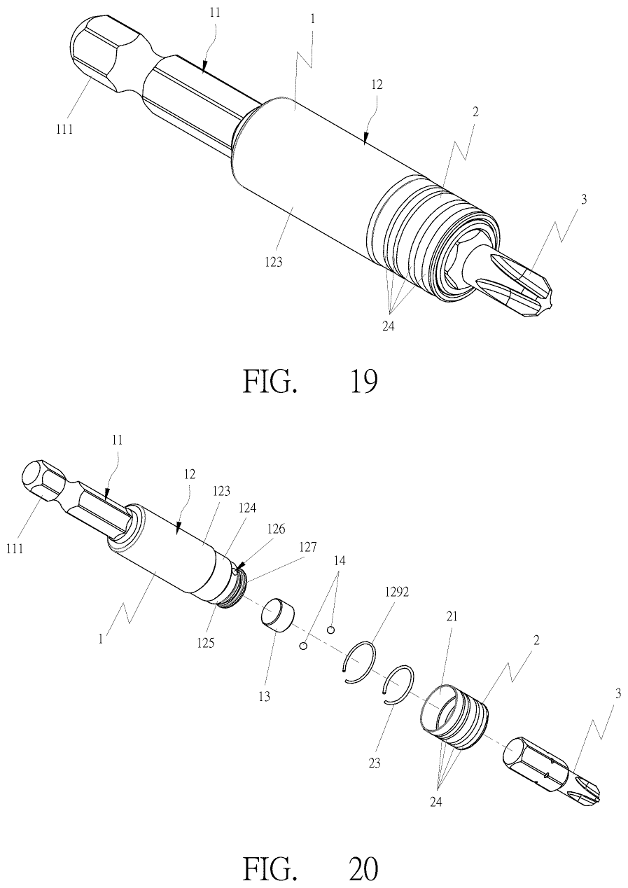

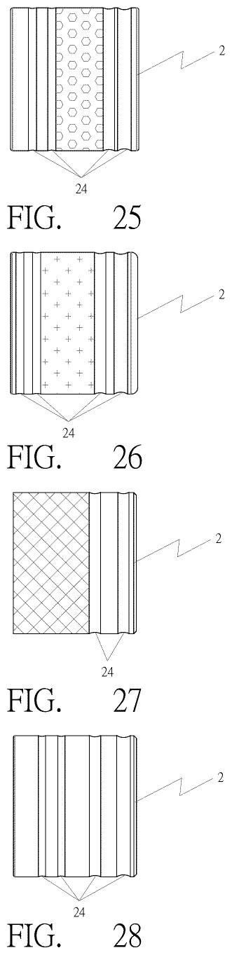

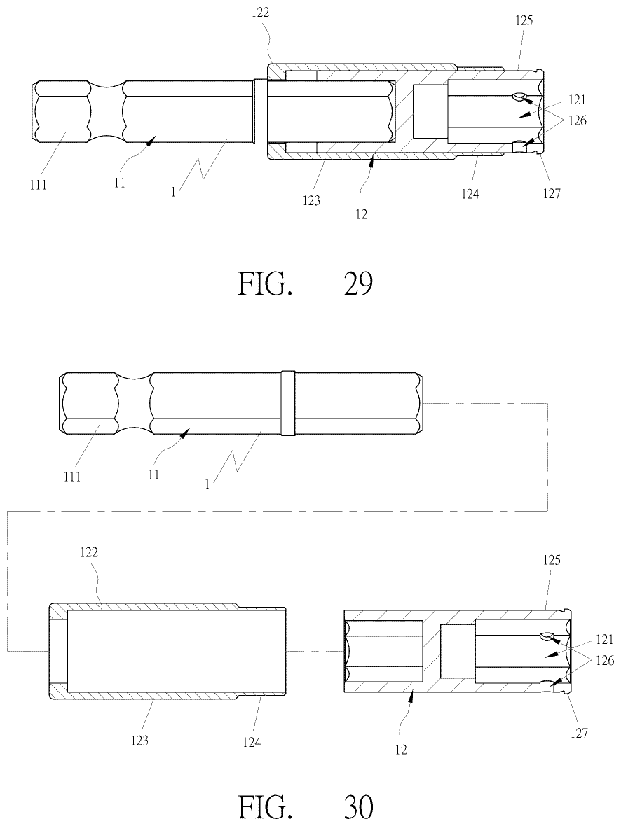

The preferred embodiments of the quick release bit holder in the present invention, as shown in FIGS. 1 to 34 includes at least a main body 1 and a sleeve 2 as main components combined together.

A first rod 11 provided at the rear end of said main body 1, a second rod 12 provided at the front end of said main body 1, and a joint 111 provided at the rear end of said first rod 11 for connecting various power screwdrivers or various screwdriver tools. The outer diameter of said second rod 12 can be smaller than the inner diameter of the nose cone of various power screwdrivers (can be less than 11.2 mm), so that said second rod 12 can move smoothly within the nose cone of various power screwdrivers. A recess 121 provided at the middle position of the front end of said second rod 12, and various bits 3 can be installed in said recess 121. When the quick release bit holder of the present invention is used to lock non-metallic objects (such as stone slabs, concrete wall, wooden boards or various non-metallic plates), a magnet 13 can be provided at the bottom of said recess 121, so that the bit 3 mounted in said recess 121 can be ferromagnetic to attract screw and facilitate the user's screw locking operation. Moreover, the chips cut from the non-metallic object will not be attracted to the bit 3 and then fall into said recess 121, causing the bit 3 to get stuck in said recess 121.

Said second rod 12 has a stepped structure, and successively provided with a first outer surrounding 123, a second outer surrounding 124 and a third outer surrounding 125 from back to front. The outer diameter of said first outer surrounding 123 is larger than the outer diameter of said second outer surrounding 124, and the outer diameter of said second outer surrounding 124 is larger than the outer diameter of said third outer surrounding 125. In this way, said sleeve 2 can be mounted on said second outer surrounding 124 and said third outer surrounding 125, and the outer diameter of said sleeve 2 can be equal to or smaller than the outer diameter of the first outer surrounding 123 of said second rod portion 12, so that said main body 1 and said sleeve 2 can move smoothly and stably in the nose cone of various power screwdrivers.

A plurality of ball holes 126 provided around said third outer surrounding 125, and a plurality of balls 14 arranged individually in each ball hole 126. Said ball 14 can partially extend into said recess 121 to catch the bit 3 in the recess 121. A first limit position member 127 provided at the front end of said third outer surrounding 125, a slope can be provided at the front end of said first limit position member 127, so as to said first limit position member 127 forms an anti-separation structure. In this way, said first limit position member 127 can assist and guide the assembly of said sleeve 2 and said main body 1, and prevent said sleeve 2 from being separated from said main body 1.

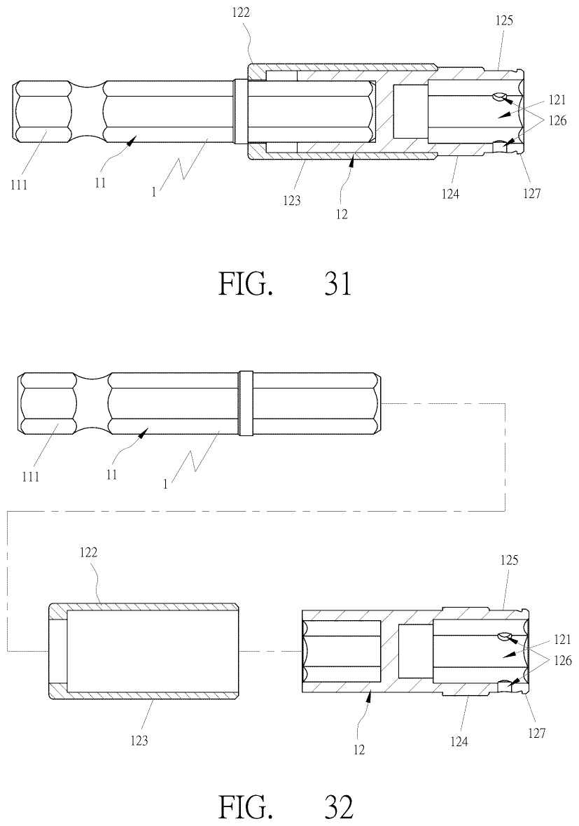

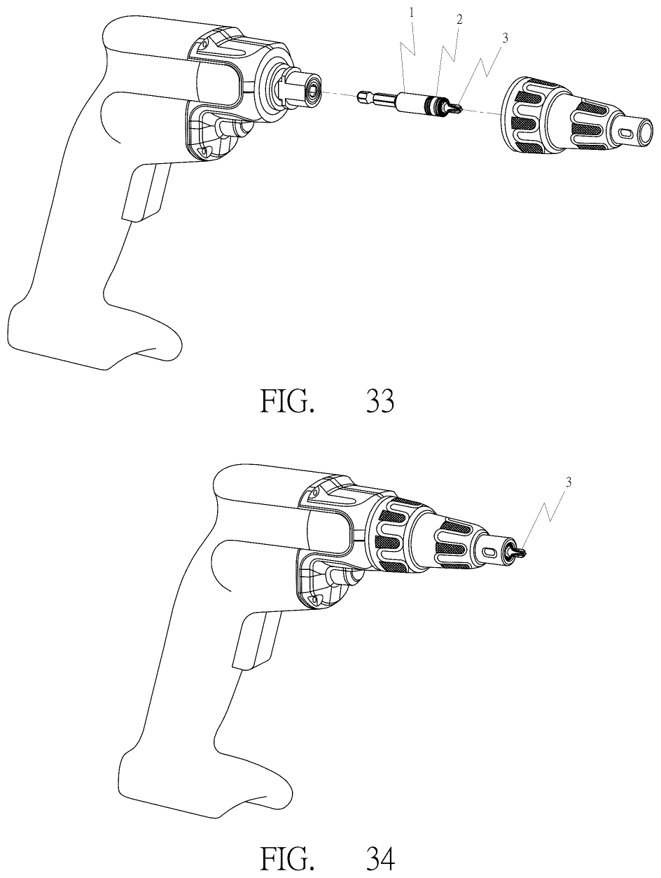

Said main body 1 may be an integrally formed structure or an assembled structure. As shown in FIGS. 29 to 32, a housing 122 can be mounted on the rear end of said second rod 12, said first rod 11 is clamped and fixed by said second rod 12 and said housing 122, and said first outer surrounding 123 provided on said housing 122. Said second outer surrounding 124 can be provided on said second rod 12 or said housing 122, depending on manufacturing requirements. As shown in FIGS. 29 and 30, when said second outer surrounding 124 is provided on said housing 122, the material of said housing 122 can be replaced to reduce more manufacturing costs and enhance market competitiveness. As shown in FIGS. 31 and 32, when said second outer surrounding 124 is provided on said second rod 12, said second outer surrounding 124 can be used as a positioning member to limit the assembly position of said housing 122.

In addition, when said magnet 13 disposed in the recess 121 of said second rod 12, said main body 1 of the assembled structure can adjust the distribution of its ferromagnetism. Said second rod 12 can be made of a ferromagnetic metal material, and said housing 122 can be made of a non-ferromagnetic material, so the outer periphery of said second rod 12 will not have ferromagnetism, to prevent the outer periphery of said second rod 12 from attracting external metal shavings or impurities and affecting the use of the bit holder. Furthermore, in order for said second rod 12 to have optimal structural strength and ferromagnetic properties, said second rod 12 must be made of relatively expensive ferromagnetic steel; and since said housing 122 can be made of low-priced, non-ferromagnetic black iron and other metal or non-metallic materials, the assembly structure of said main body 1 can save manufacturing costs and enhance market competitiveness.

An first inner surrounding 21 provided at the inner rear end of said sleeve 2, and a second inner surrounding 22 provided at the inner front end of said sleeve 2. The inner diameter of said first inner surrounding 21 is larger than the inner diameter of said second inner surrounding 22, so as to said first inner surrounding 21 can be correspondingly mounted on the second outer surrounding 124 of said second rod 12, said second inner surrounding 22 can be correspondingly mounted on the third outer surrounding 125 of said second rod 12, and the first outer surrounding 123 of the second rod 12 can be used to limit the backward movement distance of said sleeve 2. A first annular groove 221 provided at said second inner surrounding 22, and an circlip 23 provided in said first annular groove 221.

As shown in FIGS. 25 to 28, a three-dimensional anti-slip portion 24 is provided on the outer surface of said sleeve 2. Said three-dimensional anti-slip portion 24 may be a plurality of annular three-dimensional textures, a rough surface, or a composite structure of a plurality of annular three-dimensional textures and a rough surface.

In this way, after said main body 1 and said sleeve 2 are assembled and combined with each other, the circlip 23 of said sleeve 2 will clamp the third outer surrounding 125 of said main body 1 and can move on said third outer surrounding 125, so as to said sleeve 2 is allowed to move steplessly on said main body 1 (not sliding without resistance). When the circlip 23 of said sleeve 2 moves to the first limit position member 127 of said third outer surrounding 125, said first limit position member 127 will block said circlip 23 to prevent said circlip 23 from being continues to move outward and falls off.

When said sleeve 2 moves inward to the rear end, the second inner surrounding 22 of said sleeve 2 pushes the balls 14 in said ball holes 126, said balls 14 are partially pushed into the recess 121 of said second rod 12, so that the bit 3 in said recess 121 is buckled and fixed by said balls 14. When said sleeve 2 moves outward to the front end, the second inner surrounding 22 of said sleeve 2 is separated from the balls 14 in said ball holes 126, a moving space is formed between said balls 14 and the first inner surrounding 21 of said sleeve 2, so that said balls 14 can be moved outward out of the recess 121 of said second rod 12, and the bit 3 in said recess 121 can be removed and replaced.

In order to allow the user to have a better opening and closing feedback feeling when pushing the sleeve 2, and at the same time strengthen the positioning effect of the sleeve 2, as shown in the embodiment of FIGS. 1 to 6, said ball holes 126 can be provided in front of the rearmost end of the movement position of said circlip 23, so that the balls 14 in said ball holes 126 form an obstruction structure. When the circlip 23 of said sleeve 2 passes over the balls 14 in said ball hole 126, an obstructive feedback will be generated, allowing the user to more clearly feel the opening and closing status of said sleeve 2. When said sleeve 2 moves to the rearmost position, said balls 14 becomes the second positioning structure for fixing the position of said sleeve 2, this can prevent said sleeve 2 from moving to the open position due to strong vibration, and causing the bit 3 in said recess 121 to fall off.

As shown in the embodiment of FIGS. 7 to 24, said ball holes 126 can be provided at the rear end of said third outer surrounding 125, and a second limit position member 128 provided in front of said ball holes 126. A raised portion 129 provided between said first limit position member 127 and said second limit position member 128, and said raised portion 129 is an obstruction structure. When the circlip 23 of said sleeve 2 passes over said raised portion 129 to said first limit position member 127 and said second limit position member 128, an obstructive feedback will be generated, allowing the user to more clearly feel the opening and closing status of said sleeve 2. And when said sleeve 2 moves to the rearmost position, said raised portion 129 becomes a second positioning structure for fixing the position of said sleeve 2. This can prevent said sleeve 2 from moving to the open position due to strong vibration, and causing the bit 3 in said recess 121 to fall off.

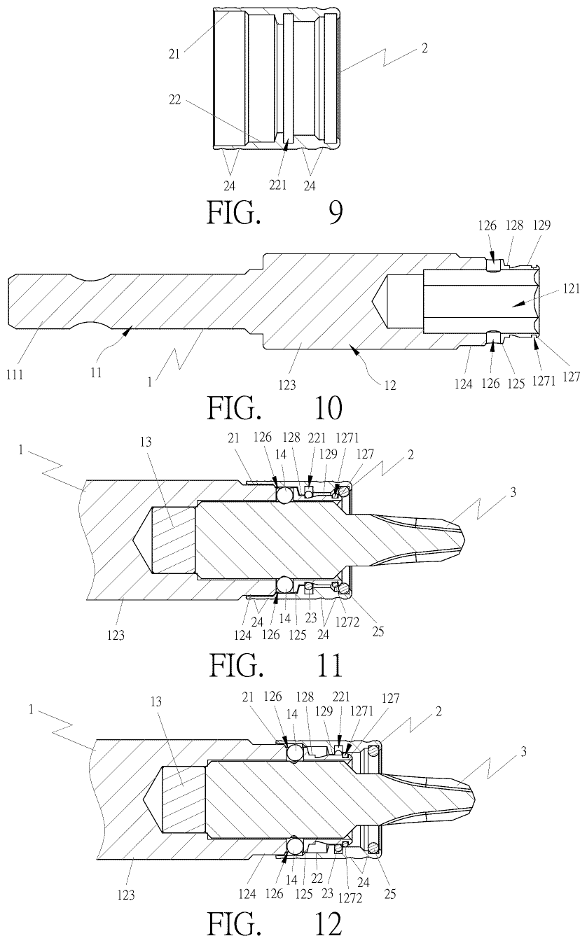

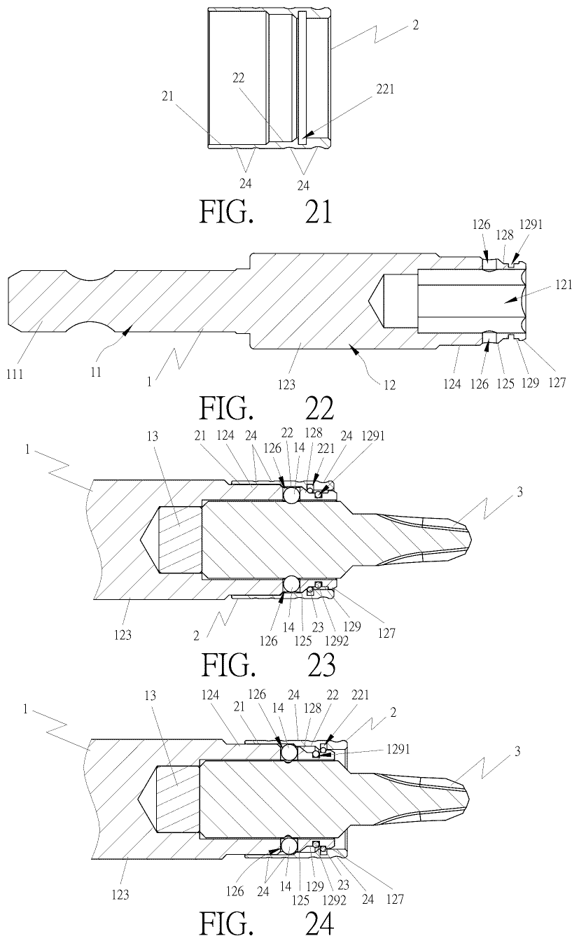

As shown in FIGS. 10 and 16, said raised portion 129 and said third outer surrounding 125 can be formed integrally. Or as shown in FIGS. 22 to 24, said raised portion 129 can be a second annular groove 1291 and a first positioning ring 1292 mounted at said second annular groove 1291 to form the same raised structure as said raised portion 129.

As shown in FIGS. 4, 10, 16 and 22, said first limit position member 127 and said second limit position member 128 can be integrally formed with said third outer surrounding 125. Or as shown in FIGS. 10 to 12, said first limit position member 127 can be a third annular groove 1271 and a second positioning ring 1292 mounted at said third annular groove 1271. In order to prevent dust and iron filings from falling into said sleeve 2, a sealing ring 25 can be provided at the front end of said sleeve 2.

It is worth mentioning that the present invention provides the second outer circumference 124 of said second rod 12 and the first inner surrounding 21 of said sleeve 2 for the purpose of increasing the holding space of said sleeve 2, allowing the user to easily hold the sleeve 2 and replace the bit 3, and the very thin first inner surrounding 21 of said sleeve 2 can prevent the user's hand from being pinched.

As shown in FIGS. 33 and 34, the quick release bit holder of the present invention, through innovative main body and sleeve, can be used with the nose cone of various power screwdrivers, and has the function of quick-release bit. Moreover, the outer diameter of the quick release bit holder of the present invention can be adjusted to the same or smaller outer diameter as various bit holders currently on the market according to usage requirements (the maximum outer diameter of the bit holder of the present invention can be less than 11.2 mm).

Words such as “one”, “an/a”, “the”, “said” and “at least one” are used herein to indicate the presence of one or more elements/component parts/and others. Terms “including”, and “having” have an inclusive meaning which means that there may be additional elements/component parts/and others in addition to the listed elements/component parts/and others. Terms “first” and “second” are used herein only as markers, and they do not limit the number of objects modified after them.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A quick release bit holder, comprising:
a main body; a first rod provided at the rear end of said main body, a second rod provided at the front end of said main body, a joint provided at the rear end of said first rod, a recess provided at the middle position of the front end of said second rod; said second rod successively provided with a first outer surrounding, a second outer surrounding and a third outer surrounding from back to front, the outer diameter of said first outer surrounding is larger than the outer diameter of said second outer surrounding, the outer diameter of said second outer surrounding is larger than the outer diameter of said third outer surrounding; a plurality of ball holes provided around said third outer surrounding, a plurality of balls arranged individually in each ball hole, said balls can partially extend into said recess, a first limit position member provided at the front end of said third outer surrounding; and
a sleeve mounted at the front end of said main body, an first inner surrounding provided at the inner rear end of said sleeve, a second inner surrounding provided at the inner front end of said sleeve, the inner diameter of said first inner surrounding is larger than the inner diameter of said second inner surrounding; said first inner surrounding correspondingly mounted on the second outer surrounding of said second rod, said second inner surrounding correspondingly mounted on the third outer surrounding of said second rod; a first annular groove provided at said second inner surrounding, an circlip provided in said first annular groove, said circlip clamped the third outer surrounding of said main body and moved thereon; a three-dimensional anti-slip portion provided on the outer surface of said sleeve.

2. The quick release bit holder according to claim 1, wherein said ball holes provided in front of the rearmost end of the movement position of said circlip, and the balls in said ball holes form an obstruction structure.

3. The quick release bit holder according to claim 1, wherein said ball holes provided at the rear end of said third outer surrounding, a second limit position member provided in front of said ball holes; a raised portion provided between said first limit position member and said second limit position member, and said raised portion form an obstruction structure.

4. The quick release bit holder according to claim 3, wherein said raised portion is provided with a second annular groove and a first positioning ring mounted at said second annular groove.

5. The quick release bit holder according to claim 1, wherein said first limit position member is provided with a third annular groove, a second positioning ring mounted at said third annular groove, and a sealing ring provided at the front end of said sleeve.

6. The quick release bit holder according to claim 1, wherein a housing mounted on the rear end of said second rod, said first rod is clamped and fixed by said second rod and said housing, and said first outer surrounding is provided on said housing.

7. The quick release bit holder according to claim 6, wherein said second outer surrounding is provided on said second rod.

8. The quick release bit holder according to claim 6, wherein said second outer surrounding is provided on said housing.

9. The quick release bit holder according to claim 6, wherein a magnet provided at the bottom of said recess; said second rod is made of a ferromagnetic metal material, and said housing is made of a non-ferromagnetic material.

10. The quick release bit holder according to claim 1, wherein a magnet provided at the bottom of said recess.

11. The quick release bit holder according to claim 1, wherein a slope provided at the front end of said first limit position member.

12. The quick release bit holder according to claim 1, wherein the maximum outer diameter of said second rod and the maximum outer diameter of said sleeve are both less than 11.2 mm.
